(19) United States
(12) Patent Application Publication
(10) Pub. No.: US 2022/0298862 A1
(43) Pub. Date: Sep. 22, 2022

(54) Step Ladder Folding Assist

(71) Applicant: Ernest Joseph Rovella, II, Coopersburg, PA (US)

(72) Inventor: Ernest Joseph Rovella, II, Coopersburg, PA (US)

(21) Appl. No.: 17/205,023

(22) Filed: Mar. 18, 2021

(51) Int. Cl. E06C 7/50; E06C 1/18

(52) U.S. Cl. CPC E06C 7/50; E06C 1/18

(57) ABSTRACT

A device for the purpose of assisting in the opening and closing of a step ladder. The inventive device is targeted for the safe engaging and disengaging of the spreader lock. The spreader lock of most step ladders requires an upward force to be applied by the operator's hand to the underside of the spreader lock. With the use of this device, the upward force can be applied indirectly and allow for the user's hands to safely remain free of the moving parts of the front rail, rear rail, and spreader.

Page 1

### CROSS-REFERENCE TO RELATED APPLICATIONS

U.S. PATENT DOCUMENTS

| | | |
|---|---|---|
| 1,342,881 | June 1920 | Udell |
| 8,186,481 | May 2012 | Moss, et al. |

### BACKGROUND OF THE INVENTION

1. Field of the Invention:

The present invention is an economically and design efficient resource to assist with the safe folding of a step ladder.

The step ladder, an improvement upon the traditional ladder, has been around for many years. The step ladder has an integrated support mechanism to allow for the ladder to be free standing and independent of the need to be supported by a wall. The step ladder is composed of a pair of front side rails that hold in place multiple steps depending on the height of the ladder. There is typically a top cap, which is the location of the hinge point, for connecting a pair of rear side rails. A spreader connects each front side rail with its opposing rear side rail to prevent the over or under extension of the ladder. Each spreader consists of two arms that attach to the opposing rails and a spreader lock that connects the spreader arms. The spreader lock allows for the arms to pivot upward when the ladder is collapsed. The lock restricts the flexion of the pivot point so that it may only fold upward; in so doing, it prevents unintentional folding of the ladder. Upward force must be applied to the spreader lock to allow for the ladder to fold.

2. Description of the Prior Art:

There are numerous versions of the step ladder that have been patented with unique innovations. Udell, U.S. Pat No. 1,342,881 mentions the need to use both hands to “break” the pivot of the spreader lock. However, Udell's innovation does not address the issue of safety as it still assumes a hand is required enter between the front and rear rails as the ladder collapses.

Moss et al. in U.S. Pat. No. 8,186,481 address the “pinching ones [sic] hand or fingers” in a very similar design as Udell. The design replaced the platform with a handle that can be accessed by reaching through the steps of the ladder. Moss et al.'s design requires multiple pieces applied in a designed manner to accomplish the goal and is described as “additional” to commonly available step ladders.

### SUMMARY OF THE INVENTION

A primary objective of the present invention is to provide a safe way to fold a step ladder. Another objective is to allow for collapsing the ladder with minimized designed deviation from the most commonly available step ladders.

Another objective is to ensure the primary objective can be done in an economically efficient manner.

Further objects of the invention will appear as the description proceeds. To enhance the understanding of the invention objectives, illustrations are provided in the form of Figures. However, the illustrations are for conceptual comprehension only and there are many variations of construction that are not exhaustively provided.

### BRIEF DESCRIPTION OF THE DRAWINGS

FIG. 1 is an angled side perspective view of the present invention on a partially folded step ladder.

FIG. 2 is a magnified angled side view of the present invention on a partially folded step ladder.

FIG. 3 is a magnified angled side view of the present invention with a first alternative configuration on a partially folded step ladder.

FIG. 4 is a magnified angled side view of the present invention with a second alternative configuration on a partially folded step ladder.

### DETAILED DESCRIPTION

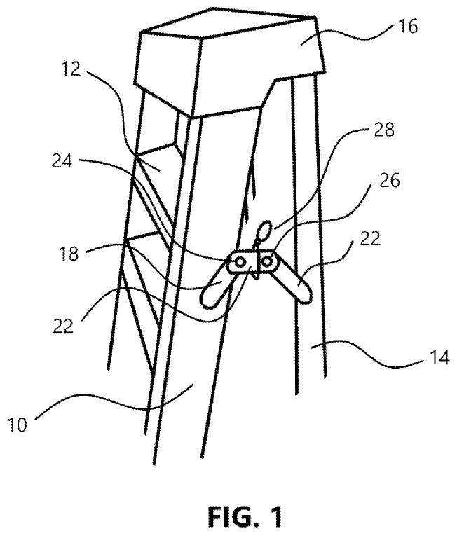

FIGS. 1 through 4 illustrate a Step Ladder Folding Assist with descriptive identification labeled with even numbers 10 through 38.

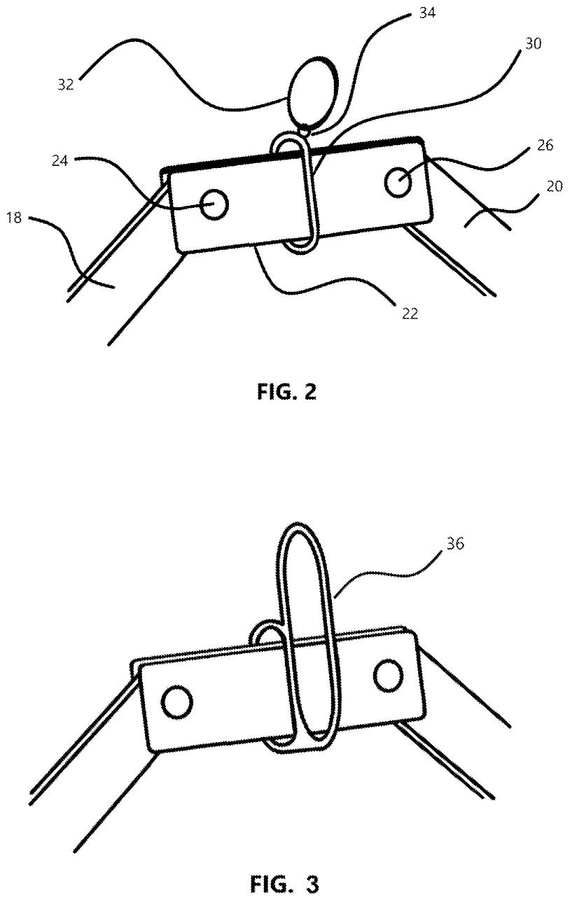

FIG. 1 presents an angled side view of a step ladder that is focused on the invention and the parts of the ladder that are relevant to the invention. A step ladder consists of pair of front rails 10 that are joined by horizonal steps 12 where both can vary in dimension depending on the intentions of the ladder. The number of steps 12 can also very with the height of the ladder. When the ladder is positioned for use, the front rails 10 are supported by a pair of rear rails 14. The front rails 10 and the rear rails 14 are joined by the ladder cap 16 which is a point of pivot to allow for the ladder to fold when not in use. To ensure the ladder is not under or over extended when in use, there is a spreader assembly on each side of the ladder defined by 18, 20, 22, 24, and 26. The spreader assembly consists of a front spreader arm 18 that attaches to the front rail 10 and a rear spreader arm 20 that attaches to the rear rail 14, on the same side of the ladder. A spreader lock 22 connects the front spreader arm 18 to the rear spreader arm 20. Both the front spreader arm 18 and the rear spreader arm 20 are attached to the respective front rail 10 and the rear rail 14 in a manner to allow free rotation. The front spreader arm 18 and the rear spreader arm 20 connect to the spreader lock 22 at the pivot point of 24 and pivot point of 26 respectively. The spreader lock 22 limits the range of the front spreader arm 18 and the rear spreader arm 20 so that they may not vary from a designed position which is typically horizonal. The invention is identified as 28 which is further described in FIG. 2.

FIG. 2 is a magnified view of the spreader lock that allows for greater detail of the invention previously identified in FIG. 1 as 28. FIG. 2 labels the previously identified parts of a step ladder including: front spreader arm 18, rear spreader arm 20, spreader lock 22, front pivot point 24, rear pivot point 26. The invention is further identified with parts 30, 32, and 34. The invention requires a point of attachment 30 to the spreader lock 22. The invention also requires a point of contact 32 for the user to access the invention. The point of contact 32 and the point of attachment 30 may require in intermediate connection 34.

The invention allows the user of the step ladder to fold the ladder by applying upward pressure at the point of contact 32. Upward force is transferred from the point of contact 32 to the intermediate connection 34, if applicable, onto the point of attachment 30, and ultimately to the spreader lock 22 between the front pivot point 24 and the rear pivot point 26. Such force disengages the spreader lock while allowing the users hands to remain free of the front spreader arm 18 and the rear spreader arm 20. The user's hands are also away from the folding front rail 10 and the rear rail 14. The use of the invention is needed on both sides of the ladder requiring two sets of the invention.

The invention can also be used to engage the spreader lock 22 when opening the ladder. Downward force can be used at the point of contact 32 which transfers to the intermediate connection 34 then to the point of attachment 30 and ultimately to the spreader lock 22.

FIG. 2 illustrates one possible configuration of the invention where the point of contact 32 is drawn as a ring-shaped object to allow for the user to apply force with their fingers. The proposed, but not limited to, ring shape eliminates any sharp edges that may inadvertently affect the user or their surrounds during the use, transport, or storage of the step ladder. The intermediate connection 34 may or may not be required to connect the point of contact 32 to the point of attachment 30. The intermediate connection 34 can also be used to alter the orientation of the point of contact 32 for user preference. Possible point of attachment 30 and intermediate connection 34 can be accomplished with the use of cable/zip ties or similar materials. Such materials can allow for the post ladder manufacturing installation of the invention.

FIG. 3 illustrates a first alternative configuration where the invention is integrated into one folding assist assembly 36. Previously described elements of the point of attachment 30, intermediate connection 34, and point of contact 32 become one piece. The folding assist assembly 36 can be a single piece of hardened plastic, metal, or similar material to be installed over the spreader lock 22 at the point of ladder assembly or by deconstruction of the spreader post ladder assembly. The folding assist assembly 36 can additionally be constructed to double as a hand hold for carrying the ladder.

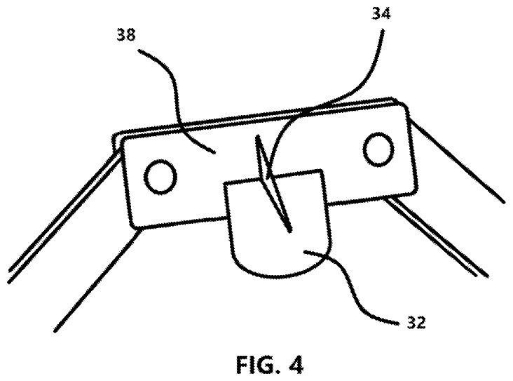

FIG. 4 illustrates a second alternative configuration where the invention is integrated into the spreader lock 22. The combined spreader lock assist 38 is a further integration including the previously described spreader lock 22, point of attachment 30, intermediate connection 34, and the point of contact 32. FIG. 4 illustrates the spreader lock assist 38 in an alternative, non-limiting configuration where the location of applied force is presented as a non-round surface.

1. A device to assist with the locking and/or unlocking of a spreader, consistent with, but not limited to, one commonly found on a step ladder, consisting of:
a point of attachment to the spreader lock, and
an area of contact connected to the point of attachment,
whereby an individual may apply force, directly or indirectly, in a near perpendicular downward or upward direction to the spreader lock to respectively engage or disengage the lock. Page 1
